(19) United States
(12) Patent Application Publication
(10) Pub. No.: US 2017/0185979 A1
(43) Pub. Date: Jun. 29, 2017

(54) METHODS, SYSTEMS, AND COMPUTER READABLE MEDIA FOR PROVIDING ELECTRIC ALTERNATIVES TO CASH ON DELIVERY (COD) ACCEPTANCE OF TENDERED GOODS AND/OR SERVICES

(71) Applicant: MasterCard International Incorporated, Purchase, NY (US)

(72) Inventors: Andres Guillermo Lopez, Yonkers, NY (US); Stephen Anthony Parento, White Plains, NY (US); Juan Carlos Leonardo Wiley Garcia, Ossining, NY (US); John Anthony Gioacchini, Yorktown, NY (US); Bryan Jacob Wexler, Melville, NY (US)

(21) Appl. No.: 14/979,793

(22) Filed: Dec. 28, 2015

(51) Int. Cl. G06Q 20/10; G06Q 20/40; G06Q 30/06

(52) U.S. Cl. CPC G06Q 20/108; G06Q 30/0601; G06Q 20/40

(57) ABSTRACT

Methods, systems, and computer readable media for providing electronic alternatives to cash on delivery (COD) acceptance of tendered goods/services are disclosed. In some aspects, the method can be performed at a clearing management server (CMS) that includes at least one processor. The CMS is configured to receive, via a communications network, an authorization request from an acquiring entity for authorizing a purchase transaction for a good/service. The authorization request can include at least a merchant identifier, a customer identifier, and a transaction amount used for authenticating the purchase. The method further includes receiving an authorization response from an issuing entity, receiving and storing a clearing record associated with the purchase transaction, receiving confirmation that the good/service is delivered to a customer at a delivery time, and processing the clearing record at the delivery time such that settlement occurs at the delivery time.

### TECHNICAL FIELD

The subject matter described herein relates to methods and systems for providing packet-based networks and/or systems that collectively obviate the need for manual acceptance of goods and/or services, for example, via cash on delivery (COD). More particularly, the subject matter described herein relates to systems, methods, and computer readable media for electronic alternatives to COD acceptance of tendered goods and/or services.

### BACKGROUND

Conventional cash on delivery (COD) transactions involve at least a customer, a merchant, and a third-party delivery service. The third-party delivery service collects payment for the purchased goods and/or services at the time and place of delivery on behalf of the merchant and keeps a portion of the proceeds as payment for making the delivery. COD transactions benefit the customer, as the customer is not required to pay for the goods and/or services until the goods are delivered (tendered).

COD transactions are labor intensive and require the third-party delivery service to manually collect and/or process the customer's payment upon delivery. This is problematic, as the customer may not be present at the time of delivery. In addition, the merchant has no assurance that the customer either will have the cash or be approved by a respective financial institution to make the purchase at the time of delivery. This contributes to wasted expenditures associated with the packaging and shipping of goods, in addition to relying upon the completion of a manual transaction, which is inherently error-prone by virtue of requiring human input of, for example, the price of the goods.

Accordingly, there exists a need for improved methods, systems, and computer readable media for electronic alternatives to COD acceptance of tendered goods and/or services that is beneficial to all parties involved in the purchase transaction.

### SUMMARY

According to one aspect, the subject matter described herein relates to methods, systems, and computer readable media for providing electronic alternatives to cash on delivery (COD) acceptance of tendered goods and/or services. An exemplary method is performed at a clearing management server (CMS) including at least one processor and includes receiving, via a communications network, an authorization request from an acquiring entity for authorizing a purchase transaction for a good or a service. The authorization request can include at least a merchant identifier, a customer identifier, and a transaction amount for use in authorizing and/or authenticating the purchase transaction. The method further includes receiving an authorization response from an issuing entity and a clearing record. The method includes storing the clearing record associated with the purchase transaction, receiving confirmation that the good or the service is delivered to a customer at a delivery time, and processing the clearing record at the delivery time such that a settlement of funds to the acquiring entity is occurs at the delivery time.

In some embodiments, an exemplary system for providing an electronic alternative to COD acceptance of tendered goods and/or services is provided. The system includes a CMS including at least one processor and at least one memory. The CMS comprises at least one communications interface for receiving an authorization request from an acquiring entity and an authorization response from an issuing entity. The CMS comprises a clearing management module (CMM) configured to receive a clearing record associated with the purchase transaction and storage for storing the clearing record associated with the purchase transaction. The CMM is configured to receive an electronic confirmation that the good or the service is delivered to a customer at a delivery time, and process the clearing record at the delivery time such that the settlement of funds to the acquiring entity occurs at the delivery time.

The subject matter described herein may be implemented in hardware, software, firmware, or any combination thereof. As such, the terms “function”, “node”, or “module” as used herein refer to hardware, which may also include software and/or firmware components, for implementing the features being described. In one exemplary implementation, the subject matter described herein may be implemented using a non-transitory computer readable medium having stored thereon computer executable instructions that when executed by the processor and memory of a computer control the computer to perform steps.

Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The subject matter described herein includes exchanging messages across a communications network, wherein the messages include payloads with payment and authorization information associated with conducting electronic commerce (e-commerce) transactions. The subject matter described herein also includes implementing electronic delays in the processing and sending of clearing files or records at a clearing manager. In some embodiments, implementing electronic delays includes invoking an application programming interface (API) configured to assist otherwise distinct applications with sharing data across a communications network.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a schematic diagram illustrating an exemplary network architecture for an electronic alternative to cash on delivery (COD) acceptance of tendered goods and/or services according to an embodiment of the subject matter described herein;

FIG. 2 is a message diagram illustrating exemplary electronic messaging between various parties of a purchase transaction for implementing an electronic alternative to COD acceptance of tendered goods and/or services according to an embodiment of the subject matter described herein;

FIG. 3 is a block diagram illustrating an exemplary system for an electronic alternative to COD acceptance of tendered goods and/or services according to an embodiment of the subject matter described herein; and

FIG. 4 is a schematic block diagram illustrating an exemplary process for an electronic alternative to COD acceptance of tendered goods and/or services according to an embodiment of the subject matter described herein.

### DETAILED DESCRIPTION

In accordance with the subject matter disclosed herein, methods, systems, and computer readable media for providing an electronic alternative to cash on delivery (COD) acceptance of tendered goods and/or services are provided. In some embodiments, methods, systems, and computer readable media described herein are not manual (e.g., performed by a human being), but rather are accomplished by virtue of electronic messaging between network entities and across a packet network for facilitating delayed execution of clearing files and/or records and thus, the settling of funds is delayed from a time of purchase until a time of delivery. Electronic alternatives described herein advantageously obviate the need for performing manual processes (e.g., the manual collection of cash and/or swiping, tapping, or otherwise contacting a payment card or device) upon delivery of a good or service.

The methods, systems, and computer readable media described herein advantageously benefit multiple parties to a payment transaction, including the customer and the merchant. For example, the customer retains the benefit of not having to pay for the goods and/or services until the time of delivery, while the merchant is afforded some level of assurance that the customer can actually afford and pay for the goods and/or services at the time of delivery. The merchant is also aware when the goods and/or services are delivered to the customer such that if the goods and/or services are accepted, merchant can automatically expect payment at the time of delivery. This may advantageously reduce the rate of return for goods and/or services.

As used herein, the phrase “time of delivery” refers to a point in time at which a buyer (customer) has access to a purchased good and/or service for determining whether the purchase will be accepted or rejected. For example and in some embodiments, a time of delivery may refer to a time at which a good is physically delivered to the buyer. In other embodiments, a time of delivery may refer to a time at which a service is redeemed, for example, a service resultant from an online/e-commerce purchase of a service, or a gift certificate for a service (e.g., a spa service, a lawn service, a restaurant service, or the like), which is payable upon delivery and/or acceptance. In further embodiments, a time of delivery may be predefined as a predetermined “acceptance window” referenced from the order date or delivery date (e.g., within 4 days of delivery, 7 days of ordering, etc.) and refers to a date by which a customer must accept the goods, or the transaction will automatically clear.

As used herein, the terms “accepted” and “acceptance” each refers to an indication that a buyer (customer) authorizes payment for the good and/or service. The indication may include an electrical signal or electrical indication signaled across a packet network and received at a clearing management server (CMS) for notifying the CMS to clear the transaction, and trigger settlement between financial entities. Acceptance may be invoked via accessing a merchant's web site to signal an acceptance, accessing a mobile application on a mobile device to signal acceptance, or signal acceptance via an API-API exchange with the CMS. Once accepted, a clearing file or records, which are created after authorization of the purchase transaction and are delayed until the time of delivery, can be submitted for settlement and disbursement of funds from the buyer's issuing bank (financial institute or account holder) to merchant's acquiring bank.

Reference will now be made in detail to exemplary embodiments of the subject matter described herein, examples of which are illustrated in the accompanying drawings. Wherever possible, the same reference numbers will be used throughout the figures, also “FIGS.”, to refer to the same or like entities.

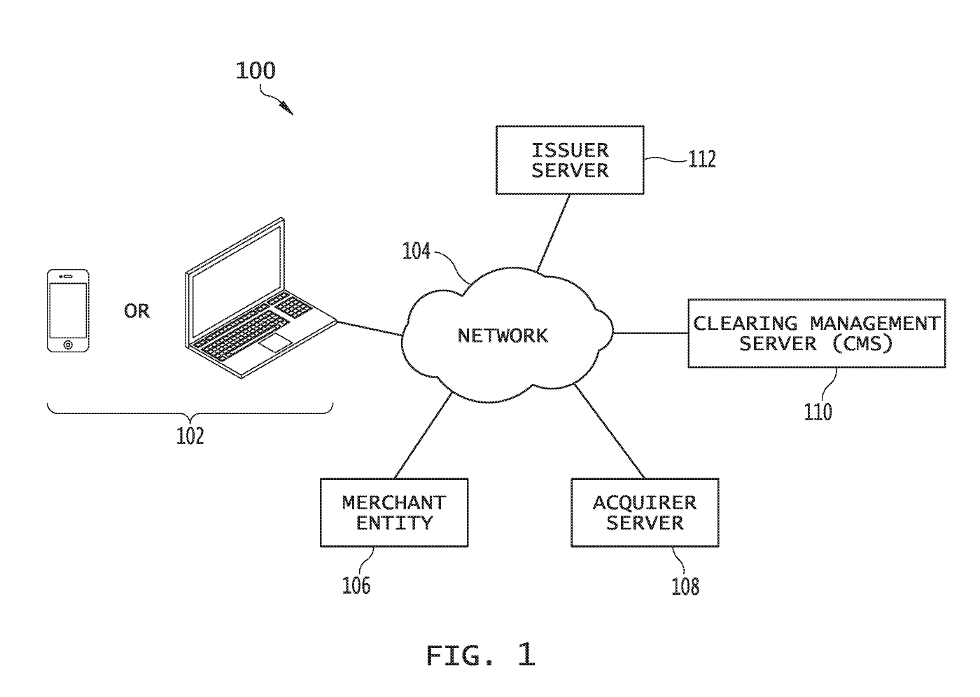

FIG. 1 is a schematic diagram illustrating an exemplary network environment or network architecture 100 associated with an electronic alternative to COD acceptance of tendered goods and/or services according to an embodiment of the subject matter described herein. In some embodiments, architecture 100 includes multiple different and/or distinct network entities for facilitating an electronic commerce (e-commerce) purchase transaction for a good and/or a service that is purchased using user equipment (UE), generally designated 102. The e-commerce purchase transaction may be one in which the customer agrees to pay for the good or service at a time of delivery thereof, and optionally upon inspection and/or acceptance of the good and/or service. Notably, architecture 100 obviates the need for the traditional (i.e., manual) collection of COD payments.

UE 102 may include any electronic device configured to access a communication network 104 and purchase a good or service from a merchant entity 106. Exemplary UEs 102 include any type of mobile or non-mobile device such as a phone, a computer, a smart device, a laptop computer, a tablet computer, a desktop computer, a smart planner or organizer, a smart television, a wearable computer (e.g., a watch or eyeglass mounted computer), or the like. For illustration purposes only, UE 102 is illustrated as including a mobile phone or a laptop computer; however, any type of communication device may be provided as UE 102.

UE 102 may access network 104 via signaling across any type of wired or wireless connection or interface (e.g., a WAN, a LAN, a WiFi connection, a radio access connection, or the like). Network 104 can include any type of communication network by which a merchant entity 106 can be accessed for ordering a good or service. Merchant entity 106 can authorize and partially clear the purchase transaction prior to delivery and payment of the purchased good or service. In some embodiments, network 104 includes a packet-based communications network (e.g., the Internet) that is accessed by UE 102 via a communications interface. Although not shown, each individual entity (e.g., 102, 106, 108, 110, 112) associated with payment architecture 100 may reside in an individual (e.g., public or private) network, which may include a same network or different networks, and are not shown for illustration purposes. Network 104 facilitates communication of data via packets or packet-based messages, which may be communicated between network entities according to any desired communication protocol as known in the art (e.g., IP, HTTP, TCP, UDP, SIP, or the like).

Although a packet-based network is shown for illustrative purposes, the subject matter described herein is not limited to a packet-based network. Any type of communications network through which messages can be exchanged electronically between computing platforms may be used without departing from the scope of the subject matter described herein. Such networks may include packet-based networks, circuit-switched networks, and combinations of packet-based and circuit-switched networks.

Network 104 may be accessed via one or more access nodes, endpoints, or ingress points such as one or more gateways or switches (not shown). For illustration purposes only, a single network 104 is illustrated for generically depicting the Internet or cloud. Network 104 can support one or more cloud based entities or services, however, as known in the art, architecture 100 may also include and/or facilitate communications for multiple different (e.g., individual or privately managed) networks and/or communications across multiple different networks for accessing services hosted or provided by various individual entities, such as an acquirer server 108, a clearing management server (CMS) 110, and/or an issuer server 112.

UE 102 may access merchant entity 106 via a website, a mobile application, or the like. In some embodiments, merchant entity 106 includes a merchant server hosted by a seller of goods and/or services (e.g., a company, a corporation, a business, a manufacturer, a supplier, a store, a person, a seller, a retailer, a partnership, or the like.). Merchant entity 106 includes functionality for facilitating a purchase transaction of an offered good and/or service, for example, where funds for the good and/or service may be authorized, but not fully cleared, until a time of delivery. That is, merchant entity 106 includes functionality for allowing a customer to purchase a good or service whereby payment is postponed until delivery and/or acceptance thereof, such that settlement of funds occurs at the time of delivery. As described in more detail below, a clearing file or record associated with a given purchase transaction may be partially processed or delayed, so that settlement of the authorized amount for the purchase is delayed and/or does not occur and is not processed until delivery and/or acceptance of the good or service by the customer. Merchant entity 106 may also include functionality for adding a good or a service (e.g., a massage, a pedicure, etc.) to a “basket”, initiating the initial authorization for a purchased/transaction amount that will satisfy payment for the transacted good or service, processing the order, shipping the order, tracking the order, storing the order, and/or allowing a customer to accept or reject the order upon delivery thereof.

In some embodiments, UE 102 accesses merchant entity 106 to place an order for a good or service. Merchant entity 106 initiates an initial authorization for the purchase to verify that funds are available in the customer's issuing bank or account. Merchant entity 106 exchanges authentication and purchase transaction information with their respective financial institution (e.g., a bank or merchant account provider) including acquirer server 108 to initiate authentication of the purchase. Merchant entity 106 communicates transaction data (e.g., a transaction amount, a merchant code, a transaction code, or the like) and payment data to acquirer server 108 via network 104. Payment data may include a card number and/or any type of identifying information that may be used to authenticate a purchase (e.g., a credit card number, a credit card type, an account number, an expiration date, a postal (zip) code, a Card Verification Value (CVV), or the like). Acquirer server 108 may then forward the transaction and payment data, via packet network 104, to a clearing management server (CMS) 110 to verify funds and/or authorize the purchase. Notably, however, the money or funds will not be debited from the customer's account to pay for the goods until the goods are delivered and optionally accepted by the customer.

Still referring to FIG. 1, CMS 110 includes functionality for facilitating and managing the electronic clearing and settlement of funds and fee assessment between a customer's account and the merchant's account. The customer's issuing account is hosted by issuer server 112 and the merchant's acquiring account is hosted by acquirer server 108. Clearing is a process by which CMS 110 verifies that funds are available in the customers issuing account, and whereby CMS 110 simultaneously receives and exchanges purchase and transaction information with acquirer server 108 and issuer server 112. CMS 110 is configured to verify funds, authorize the purchase transaction, place a hold on the funds at issuer server 112 and release the funds to acquirer server 108 upon receiving an electronic indication that the goods are delivered and/or accepted by the customer. Settlement, which is the actual exchange of monetary funds between an issuer server 112 and an acquirer server 108, which may be delayed, postponed, and/or otherwise not occur until the customer receives and optionally accepts the goods and/or services.

In some embodiments, CMS 110 is configured to authorize a purchase via exchanging electronic data or information with issuer server 112 for verifying whether a customer has the funds to make the transaction. CMS 110 then electronically communicates to acquirer server 108 for advising acquirer server 108 and merchant entity 106 as to whether merchant entity 106 should allow or deny the purchase. CMS 110 is configured to signal a numeric code across packet network 104, where the code identifies an action that merchant entity 106 should take (e.g., allow the transaction, deny the transaction, request additional information, or the like). Thus, CMS 110 can provide a merchant entity assurance that the customer can make the purchase, and hold the funds until delivery and/or acceptance of the ordered goods by the customer. The specific format of the authorization code may depend upon the access method. Regardless of the format in which an authorization response is received, CMS 110 instructs merchant entity 106 on the action to take in regards to the purchase, for example, including approving the purchase, declining the purchase, partially approving the purchase, referring the merchant to an issuer, or the like. CMS 110 includes functionality for approving or denying a purchase transaction, acquiring and holding the funds via communications with acquirer server 110, and then settling the funds by processing the interchange between issuer server 112 and acquirer server 108 at the time the goods are delivered.

CMS 110 is also configured to exchange transaction data between acquirers and issuers to clear the transaction. Transaction data may include data regarding the amount of the transaction, the merchant name, the time, date and the credit card number (or account number) used to make the partially cleared purchase. Transaction data can optionally be encrypted by CMS 110, where desired, for protecting privacy and preventing security fraud. In some embodiments, CMS 110 is configured to receive (e.g., from server 108) and store a clearing file or record, which will remain pending until the good is delivered. That is, the clearing file is generated but not processed until after the transaction is authorized, for example, and at a time of delivery. A clearing file or record includes clearing data, such as a customer identifier (a name, a numeric ID, a numeric code, an alphanumeric code, or the like), a merchant identifier (e.g., a numeric code, alphanumeric code, etc.), account information, payment information (e.g., a payment amount), or the like.

Clearing includes a process of exchanging clearing data. For example, clearing includes sending transactional information or data (e.g., the amount of the transaction, the merchant name, the time, date and the credit card number used to make the purchase, or the like) between acquirer server 108 to issuer server 112 for posting to the cardholder account upon delivery and/or acceptance of the good or service. Transaction information or data includes any data associated with a given transaction, and can be generated via acquirer server 108 and then received and/or stored at CMS 110 for presentment at a later date, namely, the day of delivery. CMS 110 is configured to receive the transaction information electrically, edit it, assess the appropriate fees, and route it to the appropriate receiver upon delivery and/or acceptance of the ordered goods and/or services. CMS 110 is configured to receive, send, store, and/or exchange clearing messages containing transactional data for facilitating the exchange or transfer funds during the settlement process, which will not occur until delivery and/or acceptance.

In some embodiments, CMS 110 includes a centralized clearing facility that is owned and operated by MasterCard® International Incorporated of Purchase, N.Y., USA, for processing, routing, and notable delaying settlement of financial transactions between MasterCard® and its members (e.g., issuers and acquirers) for providing an electronic alternative to traditional COD purchases. Settlement includes a process by which the actual funds are exchanged, and can advantageously be delayed until delivery as described herein. The funds are the monetary value of the cleared transactions that are exchanged between merchant entity 106, CMS 110, acquirer server 108, and issuer server 112.

Notably, a customer (consumer or buyer) may utilize UE 102 to purchase a good or service offered by merchant entity 106, however, funds in and/or otherwise available to the customer's account may be held and not allowed to clear (e.g., debit) the customer's account until the purchased good or service is delivered and/or indicated as accepted by the customer. Thus, the customer retains the benefit of traditional COD purchases; however, architecture 100 includes functionality for pre-authorizing, holding, and/or delaying clearance of funds needed to complete the purchase until the time of delivery. This advantageously provides merchant entity 106 assurance that the customer has the funds to pay for the goods at the time of delivery. Architecture 100 facilitates more secure transactions, as imparting the ability to electronically “accept” a delivered good and/or service further reduces the potential for security fraud.

Notably, CMS 110 is a special purpose computing device or machine that includes hardware components (e.g., one or more processor units, memory, and network interfaces) configured to execute hardware and software elements (e.g., APIs, computing modules, etc.) for the purposes of performing one or more aspects of the disclosed subject matter herein. In addition, it should be noted that CMS 110 and its components and/or functionality described herein constitute a special purpose computer that improves the technological field of electronic payments and/or transactions by obviating the need for manually collecting COD payment, and providing mechanisms for electronically delaying the clearing and settlement processes until the time of delivery of the goods to the customer.

It will be appreciated that FIG. 1 is for illustrative purposes only and that various entities, their locations, and/or their functions described above in relation to FIG. 1 may be changed, altered, added, or removed. For example, some components and/or functions may be separated or combined into one entity, e.g., CMS 110 or some functionality thereof may be integrated with any other entities associated with architecture 100.

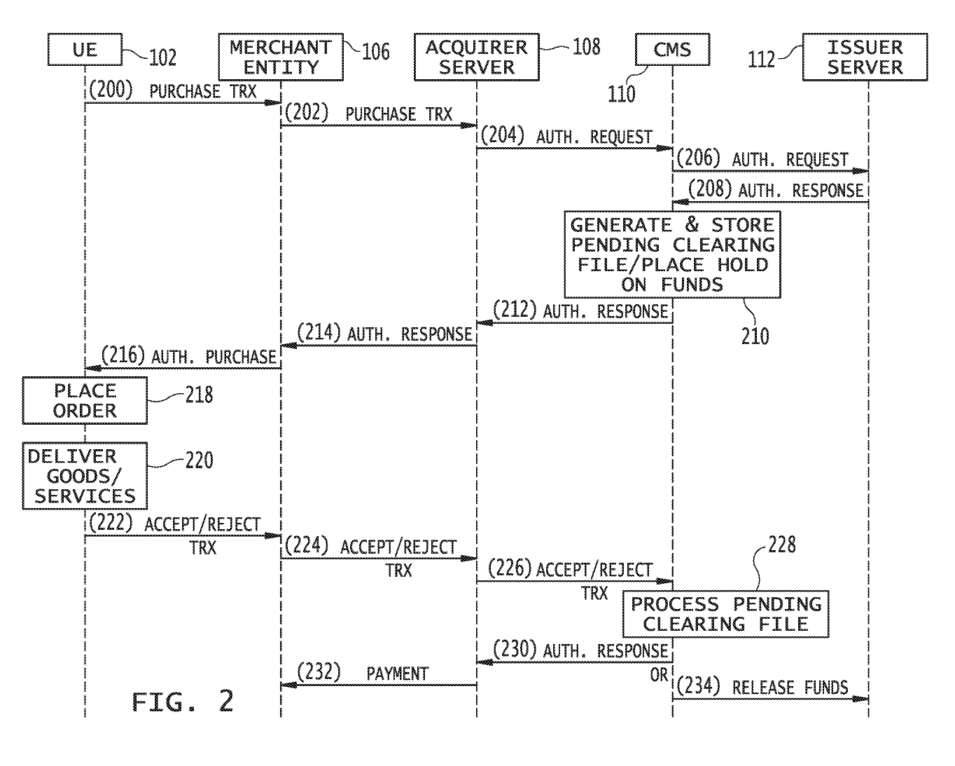

FIG. 2 is a message diagram illustrating exemplary electronic messaging exchanged between various parties of a purchase transaction for implementing an electronic alternative to COD acceptance of tendered goods and/or services according to an embodiment of the subject matter described herein. Namely, the parties to an electronic transaction that provides an alternative to traditional COD payments include a customer utilizing UE 102, merchant entity 106, acquirer server 108, CMS 110, and issuer server 112. As noted above, CMS 110 manages clearing files representative of monetary funds that will later move from customer's issuer server 112 to merchant's acquirer server 108.

At line 200, UE 102 initiates a purchase transaction for a good or service across a packet network such as the Internet, via a merchant web page, a mobile application, or the like. At line 202, merchant entity 106 forwards details (e.g., transactional data) regarding the purchase transaction to acquirer server 108. Transactional data may include the amount of the transaction, the merchant name, the time/date and the credit card (or account) number used to make the purchase so that CMS 110 may partially clear the purchase. Merchant entity 106 may forward packet data to acquirer server 108 including a payload having a merchant identifier, a purchase identifier, transactional information, payment information, and/or customer information.

Acquirer server 108 contacts CMS 110 at line 204 and sends CMS 110 an authorization request. CMS 110 may receive packet data from acquirer server 108 including a payload with the merchant identifier, the purchase identifier, transactional information (e.g., transaction time/date, amount), payment information, and/or customer information so that CMS 110 can authorize the purchase via customer's issuing entity (a bank, financial institution, account provider) including issuer server 112. At lines 206 and 208, respectively, CMS 110 sends an authorization request to issuer server 112 and issuer server responds with an authorization response. The authorization response indicates to CMS 110 whether customer, via UE 102, is authorized to make the purchase. If the customer is authorized to make the purchase and at block 210, CMS 110 generates and/or receives and stores a clearing file that can remain pending until the ordered good/service is delivered. CMS 110 also places a hold on funds at issuer server 112 so that the funds can be held until delivery of the goods and/or acceptance by the customer.

At lines 212 and 214, CMS 110 instructs merchant entity 106 to authorize the purchase, via acquirer server 108, by sending an authorization response message to authorize the transaction. If the purchase is allowed, CMS 110 sends a packet having a payload including an authorization code (e.g., a numeric code or sequence of numbers that are interpreted as instructing merchant entity to authorize or decline the purchase. At line 216, merchant entity 106 sends UE 102 a message indicating that the purchase is authenticated and approved. The order for the good or service is placed at block 218. Thus, upon placement of the order at block 218, the customer has communicated a card or account information, the information has been verified for the purchase amount, and a clearing file will be generated and stored in a storage element at CMS 110 and remain pending until a time of delivery.

Notably, CMS 110 is configured to receive a clearing file (record) from acquirer server 108, and store the clearing file for delaying processing and settlement of the purchase transaction until the goods are delivered at block 220, and ultimately accepted by the customer via an electronic message communicated from UE 102. Upon delivery, the customer can inspect the goods and utilize UE 102 to send CMS 112 confirmation that the goods are received and accepted. The confirmation of delivery and acceptance triggers clearing and settlement (i.e., the movement of money) and advantageously saves time and expense of having to process refunds, as the customer retains the benefit to reject the goods at the time of delivery. Where the customer rejects the goods, the pending clearing file will be terminated, and no money changes hands.

At line 222, UE 102 sends an electronic indication of whether the goods are accepted or rejected. At lines 224 and 226, respectively, the indication of the acceptance or rejection is forwarded to acquire server 108 and CMS 110. At block 228, the pending clearing file is processed. If the goods and services are accepted, CMS 110 notifies acquirer server at line 230 and instructs acquirer server 108 to pay merchant entity at line 232. Where the goods or services are rejected, CMS 110, at line 234, instructs issuer server 112 to release the hold and/or release the funds that were on hold pending delivery and acceptance of the purchased good.

The message flow illustrated in FIG. 2 is advantageous, as delivery confirmation and acceptance/rejection are transparent to all parties of the purchase transaction, and merchant entity 106 knows exactly when an order is delivered and accepted or rejected. Thus, merchant entity 106 can expect payment at the time of delivery. Utilizing electronic messages to confirm delivery and/or accept or reject delivered goods and/or services prevents clearing and settlement of the purchase transaction until the customer has received and inspected the goods. In some embodiments, CMS 110 parses an API to initiate settlement and/or the release of funds. CMS 110 includes functionality of preventing clearing from processing all the way through until the customer receives and/or accepts the goods.

Notably, a customer is not required to be physically present and/or immediately prompted to accept the goods. CMS 110 includes functionality for configuring a window of time by which a customer must accept the goods, or clearing will automatically occurs. For example, CMS 110 may set a window for acceptance within 1 day of delivery, 2 days of delivery, 7 days after the order was placed, or the like. The delivery window may also be adjusted in cases something unforeseen happens, for example, a shipping delay resulting from a storm.

It will be appreciated that FIG. 2 is for illustrative purposes only and various messages, message sequencing and/or message content described above in relation to FIG. 2 may be changed, altered, edited, or removed where necessary. For example, some messages may be separated or combined into more than one or less than one message.

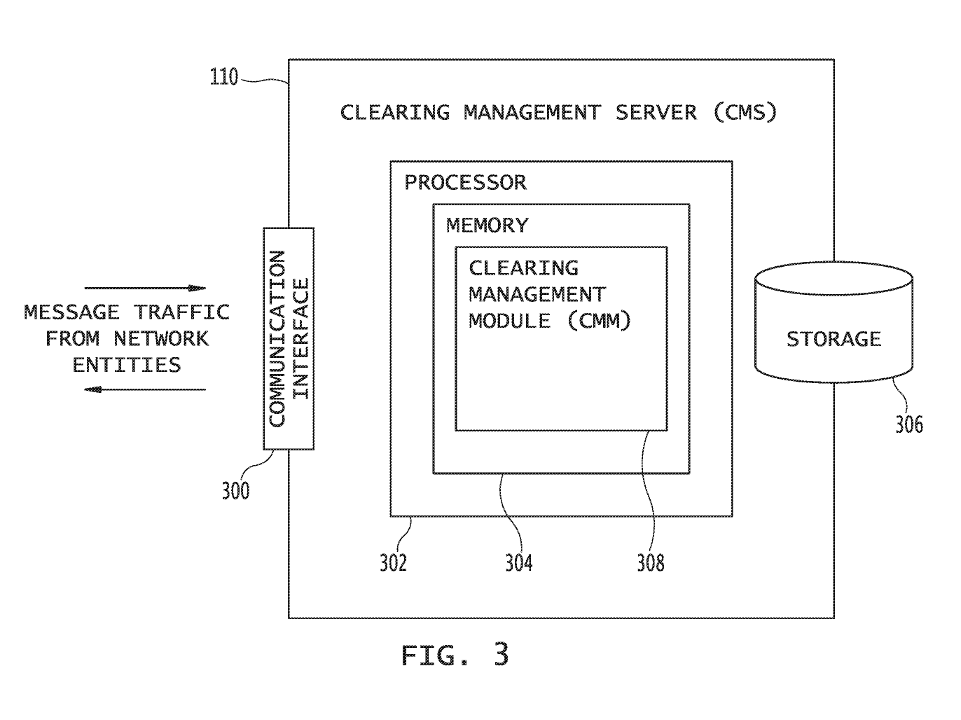

FIG. 3 is a block diagram illustrating an exemplary system for providing an electronic alternative to COD acceptance of tendered goods and/or services according to an embodiment of the subject matter described herein. FIG. 3 illustrates CMS 110, which includes a system or device for electronically delaying/postponing clearing and settlement of funds for a purchased good, until the good is delivered and/or accepted (e.g., electronically) by a customer.

In some embodiments, CMS 110 includes at least one communication interface 300, at least one processor 302, and at least one memory 304 (e.g., a memory component, element or device). CMS 110 is configured to utilize interface 300, processor 302, and memory 304 for executing software to exchange information (e.g., via an API-API exchange) between a customer, merchant, issuing, and/or acquiring entities, for example, to exchange financial transaction data and/or customer account information so that clearing and settlement may remain pending until an ordered good and/or service is delivered and optionally accepted. In some embodiments, packets or message traffic (e.g., authorization requests, authorization responses, or the like) is sent, received and/or otherwise communicated or exchanged between CMS 110 and other network entities via communication interface 300 according to methods described herein for providing an electronic alternative to COD.

Although only one communications interface 300 is illustrated, one or more additional communications interfaces 300 may be provided whereby connections to the network 104 (FIG. 1) and other remote servicers are established. That is, communications interface 300 may include an interface by which packet data messages are received, sent, and/or exchanged. CMS 110 may include a hardware computing device and/or a computing platform including a communications interface 300 by which CMS 110 transfers and exchanges electronic financial transaction data, account data, and information for clearing and settlement. CMS 110 is configured to receive an indication that a customer is making a purchase, authorize the purchase, place a hold on funds needed for the purchase, and receive and store a clearing file for delaying clearing and/or settlement, at least until a time of delivery.

In some embodiments, processor 302 includes a microprocessor, such as a central processing unit (CPU), or any other hardware-based processor unit that is configured to execute and/or utilize software to communicate with multiple financial and/or merchant service providers (e.g., or servers associated therewith) for initiating and processing electronic payments, so that clearing and settlement occur upon delivery as opposed to the actual date that the good or service is ordered.

In some embodiments, CMS 110 further includes a clearing management module (CMM) 308 executed by processor 302 and stored in memory 304. CMM 308 may include hardware, software and/or firmware components for implementing an electronic alternative to COD as described herein. In one exemplary implementation, CMM 308 includes functionality for authorizing a purchase, holding funds, receiving a clearing file (record) from acquirer server 208 representative of how funds are to be managed or divided up at various entities upon settlement, and processing the stored (pending) clearing file at a time of delivery. CMM 308 is configured to store the pending clearing file or record in storage 306 until it receives an electronic indication that a customer has received and/or accepted the goods. Upon authorization from the customer, CMM 308 extracts the stored clearing file from storage 306 and processes or submits the pending clearing file to acquirer server 108 (FIG. 1) for settlement. Thus, CMM 308 prohibits distribution and settlement of funds in advance of receiving an electronic signal or packet message from UE 102 (e.g., FIG. 1) indicating whether the good/service are received and accepted or rejected.

In some embodiments, CMM 108 includes functionality for reading, parsing, and/or otherwise processing APIs to determine a delivery date/time and/or acceptance of a purchase. Notably, CMM 110 is configured to leverage APIs from third-party servers to obtain specific delivery information, an indication of acceptance or rejection, as well as convey clearing and settlement information to the issuing and acquiring servers. Storage 306 can comprise any type of storage element, component, or device, not limited to a database, a data table, a cache, a storage drive, or any other collection of records or information including pending transactional data for processing upon delivery of an ordered good or service.

In some embodiments, memory 304 (e.g., a memory element or device) of CMS 110 includes a random access memory (RAM), a read only memory (ROM), an optical read/write memory, a cache memory, a magnetic read/write memory, a flash memory, or any other non-transitory storage media. In one embodiment, processor 302 and memory 304 may be used to execute and manage the operation of CMS 110. In some embodiments, memory 304 includes any medium that is configured to store (e.g., locally) clearing data used in processing payments and settlement to different providers (e.g., acquirer servers and merchant entities).

In some embodiments, a clearing file includes clearing not limited to a transaction identifier, a transaction data/time, a merchant identifier, a customer identifier (e.g., a name, code, or account identifier), a customer account number, a payment type and/or a payment identifier (e.g., a payment card or account number), a payment amount, or the like, used to look up a transaction for clearing and settlement. Upon delivery and acceptance of the ordered good or service, CMS 110 is configured to extract and process a respective pending clearing file for managing and assessing the distribution of funds, fees, etc., among the merchant, acquirer, and issuer. Notably, CMS 110 may delay settlement (e.g., so that settlement occurs at delivery) via leveraging APIs and automatically submit a payment on a customer's behalf once the good or service is delivered and/or accepted. For example, a customer can instruct CMS 110 to process pending clearing files in storage 306 and initiate settlement of funds between issuer institution, acquiring institution, and merchant entity.

Although FIG. 3 depicts CMS 110 as a single node or network element, CMS 110 may further include a plurality of network elements, a plurality of network components, etc., without departing from the scope of the instant subject matter. In some embodiments, CMS 110 provides electronic alternatives to manual COD payment methods, which may be incorporated with any suitable component or multiple hardware components. CMS 110 may include multiple processors, memory elements, interfaces, or the like.

Notably, CMS 110 includes a special purpose computer device or machine that includes hardware components (e.g., one or more processor units, memory, and network interfaces) configured to execute hardware and software elements (e.g., APIs, packets, modules, etc.) for the purposes of performing one or more aspects of the disclosed subject matter herein. In addition, it should be noted that CMS 110 and its components and/or functionality described herein constitute a special purpose computer that improves the technological field pertaining to electronic payment transactions, clearing transactions, and/or settlement transactions by providing mechanisms for delaying clearing and/or settlement until delivery and/or acceptance of a good or service.

It will be appreciated that FIG. 3 is for illustrative purposes only and that various components, their locations, and/or their functions described above in relation to FIG. 3 may be changed, altered, added, integrated, segregated, or removed. For example, some components and/or functions may be separated or combined into more than one entity.

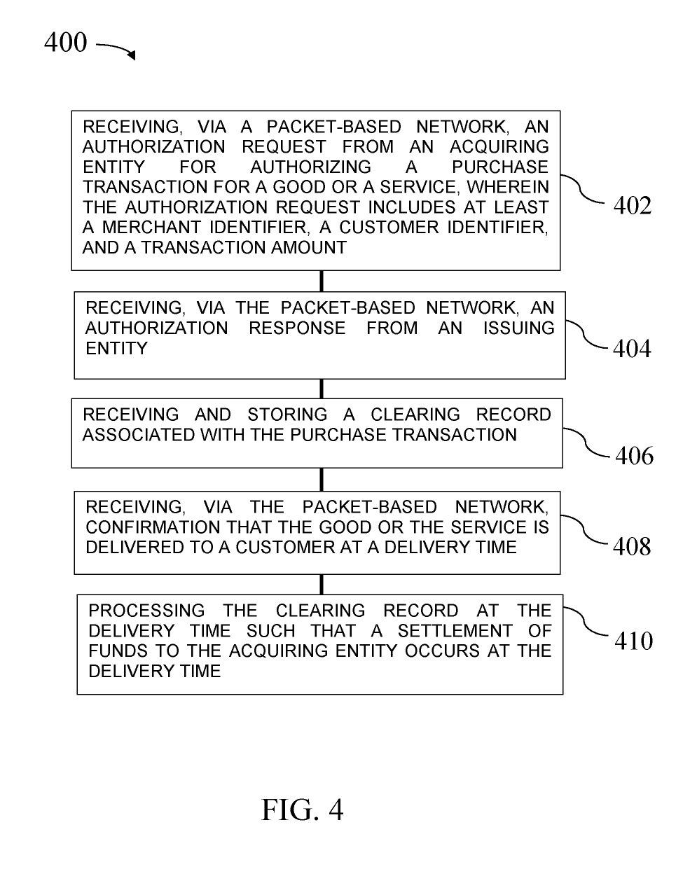

FIG. 4 is a schematic block diagram illustrating an exemplary process 400 for providing an electronic alternative to COD acceptance of tendered goods and/or services according to an embodiment of the subject matter described herein. The process may occur at a CMS (e.g., CMS 110, FIG. 3) which is a computing platform including at least one processor for receiving (e.g., from acquirer server 108) and storing a pending clearing file until delivery and/acceptance of the ordered good or service. CMS 110 (FIG. 3) includes functionality for parsing APIs to confirm the delivery and/or acceptance of the ordered good or service, and processing the pending file upon delivery to that settlement occurs when the customer receives and/or accepts the good. Electronic processes shown and described herein advantageously obviate the need for manually processing COD payments.

In block 402, CMS is configured to receive, via a packet-based network, an authorization request from an acquiring entity (e.g., acquirer server 108, FIG. 2) for authorizing a purchase transaction for a good or a service. The authorization can comprise a packet having a payload comprising at least a merchant identifier (e.g., a numeric or alphanumeric code), a customer identifier (e.g., a numeric or alphanumeric account number or code), and a transaction amount (e.g., the purchase amount) for presentation to an issuing entity (e.g., issuing server 112). This information is used by CMS during an exchange with an issuing entity for authorization and/or authenticating the purchase transaction.

At block 404, CMS is configured to receive, via the packet-based network, an authorization response from an issuing entity. The issuing entity notifies CMS whether or not to approve or decline a transaction.

At block 406, CMS is configured to receive and store a clearing record associated with the purchase transaction. Clearing is the movement of data from the acquirer server to CMS and from CMS to the issuer server. Clearing records include any information associated with a purchase transaction, including a purchase amount and a transaction date and time.

In block 408, CMS is configured to receive, via the packet-based network, confirmation that the good or the service is delivered to a customer at a delivery time. The confirmation may be electronic, and leveraged from APIs provide by third party servers (e.g., telecommunication servers, delivery service servers, etc.).

In block 410, CMS is configured to process the clearing record at the delivery time. Thus, the settlement of funds to the acquiring entity occurs at the time of delivery.

It will be appreciated that exemplary process 400 is for illustrative purposes and that different and/or additional actions may be used. It will also be appreciated that various actions associated with exemplary process 400 may occur in a different order or sequence.

As noted above, CMS (e.g., 110, FIG. 3) and/or functionality described herein constitute a special purpose computer. Further, it will be appreciated that CMS (e.g., 110, FIG. 3) and/or functionality described herein can improve the technological field pertaining to packet communications for clearing and settling financial transactions and/or security or authentication thereof. Clearing management, including postponing (e.g., delaying) the processing of clearing files until a time of delivery advantageously obviates the need for manually processing COD transactions. Notably, coordination of authorization, clearing, and settlement via CMS (e.g., 110, FIG. 3) is necessarily rooted in computer technology in order to overcome a problem specifically arising in the realm of computer networks (i.e., receiving, storing and exchanging, via a CMS computing platform, clearing messages for delaying settlement until a good or service is delivered and/or accepted).

Systems, methods, and computer readable media for providing electronic alternatives to COD acceptance of tendered goods and/or services may provide, for example and without limitation, one or more of the following beneficial technical effects: facilitating electronic alternatives to COD thereby minimizing and/or eliminating the need to manually collect payments; electronic delay and release of clearing files; more efficient electronic payment systems; more secure electronic payment systems; increased assurance that a customer can pay for a delivered good; no payment due until the customer has accepted the good; and/or payment systems that are more efficient and beneficial to all parties to a transaction (e.g., merchant, customer, acquirer, and issuer).

While the subject matter has been has been described herein in reference to specific aspects, embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method for providing an electronic alternative to cash on delivery (COD) acceptance of tendered goods and/or services, the method comprising:
at a clearing management server (CMS) including at least one processor:
receiving, via a communications network, an authorization request from an acquiring entity for authorizing a purchase transaction for a good or a service, wherein the authorization request includes at least a merchant identifier, a customer identifier, and a transaction amount;
receiving, via the communications network, an authorization response from an issuing entity;
receiving and storing a clearing record associated with the purchase transaction;
receiving, via the communications network, confirmation that the good or the service is delivered to a customer at a delivery time; and
processing the clearing record at the delivery time such that a settlement of funds to the acquiring entity occurs at the delivery time.

2. The method according to claim 1, wherein the authorization request and the authorization response are received at a communications interface that is configured to receive packet communications.

3. The method according to claim 1, wherein the clearing record is stored in a database, a table, a cache, or a storage drive.

4. The method according to claim 1, wherein receiving, via the communications network, confirmation that the good or the service is delivered to a customer at a delivery time comprises leveraging an application programming interface (API) from a third party server.

5. The method according to claim 1, further comprising receiving, via the communications network, confirmation that the good or the service is accepted by the customer.

6. The method according to claim 1, further comprising receiving, via the communications network, confirmation that the good or the service is rejected by the customer.

7. The method according to claim 5, wherein confirmation that the good or the service is accepted includes receiving, at the CMS, an electronic communication from a user element.

8. The method according to claim 1, wherein the clearing record identifies a transaction by a transaction date and time.

9. The method according to claim 1, further comprising placing a hold on funds at the issuing entity prior to receiving the clearing record.

10. The method according to claim 1, further comprising specifying a time period during which the good or the service is to be accepted, wherein exceeding the time period results in automatic clearing and settlement of funds.

11. The method according to claim 1, wherein processing the clearing record at the delivery time includes facilitating movement of funds to the acquiring entity or terminating the clearing record and releasing funds back to the issuing entity.

12. A system for providing an electronic alternative to cash on delivery (COD) acceptance of tendered goods and/or services, the method comprising:
a clearing management server (CMS) including at least one processor and at least one memory, wherein the CMS comprises:
at least one communications interface for receiving an authorization request from an acquiring entity and an authorization response from an issuing entity, wherein the authorization request is communicated across a packet network and includes at least a merchant identifier, a customer identifier, and a transaction amount;
a clearing management module (CMM) configured to receive a clearing record associated with the purchase transaction; and
storage for storing the clearing record associated with the purchase transaction; and
wherein the CMM is configured to receive an electronic confirmation that the good or the service is delivered to a customer at a delivery time and process the clearing record at the delivery time such that a settlement of funds to the acquiring entity occurs at the delivery time.

13. The system according to claim 12, wherein the clearing record is stored in a database, a table, a cache, or a storage drive.

14. The system according to claim 12, wherein confirmation that the good or the service is delivered is determined by leveraging an application programming interface (API) from a third party server.

15. The system according to claim 12, wherein the good or the service is accepted at the delivery time by the customer via a user element.

16. The system according to claim 12, wherein the good or the service is rejected at the delivery time by the customer via a user element.

17. The system according to claim 12, wherein the clearing record identifies a transaction by a transaction date and time.

18. The system according to claim 12, wherein the CMS is configured to place a hold on funds at the issuing entity prior to receiving the clearing record.

19. The system according to claim 12, wherein the CMM is configured to set a time period during which the good or the service is to be accepted, and wherein exceeding the time period results in CMM automatically clearing the purchase transaction and facilitating settlement of funds.

20. The system according to claim 12, wherein the packet network comprises the Internet.

21. A non-transitory computer readable medium having stored thereon executable instructions that when executed by the processor of a computer control the computer to perform steps comprising:
receiving, via a communications network, an authorization request from an acquiring entity for authorizing a purchase transaction for a good or a service, wherein the authorization request includes at least a merchant identifier, a customer identifier, and a transaction amount;
receiving, via the communications network, an authorization response from an issuing entity;
receiving and storing a clearing record associated with the purchase transaction;
receiving, via the communications network, confirmation that the good or the service is delivered to a customer at a delivery time; and
processing the clearing record at the delivery time such that a settlement of funds to the acquiring entity occurs at the delivery time.
